(19) United States
(12) Patent Application Publication
(10) Pub. No.: US 2010/0129732 A1
(43) Pub. Date: May 27, 2010

(54) Electrochemical Cell Stack Assembly

(76) Inventors: James F. McElroy, Suffield, CT (US); Michael Gordon, (US); Lisa Gordon, Anaheim, CA (US)

Correspondence Address: TROP, PRUNER & HU, P.C., 1616 S. VOSS ROAD, SUITE 750, HOUSTON, TX, 77057-2631, US

(21) Appl. No.: 12/433,410

(22) Filed: Apr. 30, 2009

Related U.S. Application Data
(60) Provisional application No. 61/126,138, filed on May 1, 2008.

(51) Int. Cl. H01M 8/02

(52) U.S. Cl. 429/514

(57) ABSTRACT

A technique includes providing a loading force member to extend between end plates to compress flow plates of a stack of electrochemical cells together. The technique includes positioning the member in a region of the stack in which a maximum pressure force is exerted due to the operation of the stack.

This application claims the benefit under 35 U.S.C.§119(e) to U.S. Provisional Patent Application Ser. No. 61/126,138, entitled, “ELECTROCHEMICAL CELL STACK ASSEMBLY,” which was filed on May 1, 2008, and is hereby incorporated by reference in its entirety.

### BACKGROUND

The invention generally relates to an electrochemical cell stack assembly.

A fuel cell is a type of electrochemical cell, which converts chemical energy directly into electrical energy. For example, one type of fuel cell includes a proton exchange membrane (PEM) that permits only protons to pass between an anode and a cathode of the fuel cell. Typically PEM fuel cells employ sulfonic-acid-based ionomers, such as Nafion, and operate in the room temperature to 90° Celsius (C) temperature range. Another type employs a phosphoric-acid-based polybenziamidazole, PBI, membrane that operates in the 150° to 200° temperature range. At the anode, diatomic hydrogen (a fuel) is reacted to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:

Anode: H₂→2H⁺+2e⁻ Equation 1

Cathode: O₂+4H⁺+4e⁻2H₂O Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one cell of the stack. The plates may include various surface flow channels and orifices to, as examples, route the reactants and products through the fuel cell stack. Electrically conductive gas diffusion layers (GDLs) may be located on each side of a catalyzed PEM to form the anode and cathodes of each fuel cell. In this manner, reactant gases from both the anode and cathode flow-fields may diffuse through the GDLs to reach the catalyst layers.

The PEM fuel cell is only one type of fuel cell. Other types of fuel cells include direct methanol, alkaline, phosphoric acid, molten carbonate, and solid oxide fuel cells.

In contrast to a fuel cell, an electrochemical cell may alternatively be configured to function as an electrolyzer, which produces hydrogen and oxygen from electricity and water. More specifically, the following reactions occurring at the anode and cathode of the cell:

Anode: 2H₂O→O₂+4H⁻+4e⁻ Equation 3

Cathode: 4H⁻+4e⁻2H₂ Equation 4

The electrochemical cell may also be configured to function as gas purifier, or pump. In this configuration, electrical energy is provided to the electrochemical cell to cause a gas species (such as hydrogen) at the anode side of the cell to be selectively transported to the cathode side of the cell.

Within the next decade, the demand for purified, compressed reactant gas is expected to increase dramatically. One factor that is driving this demand is the expected shift from oil-based fuels and internal combustion engines to hydrogen fuel and fuel cells.

Hydrogen production will likely be conducted by a variety of means. Examples include water electrolysis, methane reformation, propane reformation, alcohol reformation, sugar reformation, and/or oil and gasoline reformation. In the case of each of these examples, the product of the generation process is most frequently an impure, low pressure stream, which contains hydrogen gas as one of many constituents. The ideal product, however, would be a pure, dry pressurized hydrogen stream, which can be used directly by either the end application or which can be easily stored in pressurized gas containers.

Another factor driving an increased demand for purified, compressed reactant gases is the continued rapid increase in the industrialization of processes, which utilize reactant gases for materials microstructure processing. The semiconductor industry, as an example, uses large quantities of extremely pure, compressed reactant gases, such as hydrogen and oxygen.

### SUMMARY

In an embodiment of the invention, a technique includes providing a loading force member to extend between end plates to compress flow plates of an electrochemical cell stack assembly together. The technique includes positioning the loading force member in a region of the stack near where a maximum expansion force is exerted on the flow plates due to the operation of the stack.

In another embodiment of the invention, a technique includes compressing flow plates of an electrochemical cell stack between end plates and extending a loading force member through the stack to compress the flow plates. The technique includes positioning the loading force member to extend substantially along a center line of the stack.

In an another embodiment of the invention, an apparatus includes a stack of flow plates to form electrochemical cells, which generate a pressure force on the flow plates due to operation of the cells. The apparatus includes end plates and a loading member that extends between the end plates to maintain compression of the flow plates. The loading force member is positioned to maximize a compression force on the flow plates in a region of the stack in which the pressure force is maximized.

In yet another embodiment of the invention, an apparatus includes a stack of flow plates to form electrochemical cells and a loading force member. The loading force member extends substantially along a center line of the stack to maintain compression of the flow plates.

Advantages and other features of the invention will become apparent from the following drawing, description and claims.

### BRIEF DESCRIPTION OF THE DRAWING

FIG. 1 is a schematic diagram illustrating an electrochemical cell that is configured to produce a purified gas according to an embodiment of the invention.

FIG. 2 is a schematic diagram of an electrochemical cell pump formed from cascaded electrochemical cell stacks according to an embodiment of the invention.

FIG. 3 is a schematic diagram of a system to purify, compress and store gas according to an embodiment of the invention.

FIG. 4 is a schematic diagram of a fuel cell system according to an embodiment of the invention.

FIGS. 5 and 6 illustrate different electrochemical cell stack assemblies.

FIG. 7 is a flow diagram depicting a technique to prevent bowing of flow plates of an electrochemical cell stack assembly according to an embodiment of the invention.

FIG. 8 is an illustration of pressure forces generated by operation of an electrochemical cell stack according to an embodiment of the invention.

FIG. 9 is a schematic diagram of an electrochemical cell stack assembly according to an embodiment of the invention.

FIG. 10 is a view of the cathode side of a flow plate of the stack assembly of FIG. 9 according to an embodiment of the invention.

### DETAILED DESCRIPTION

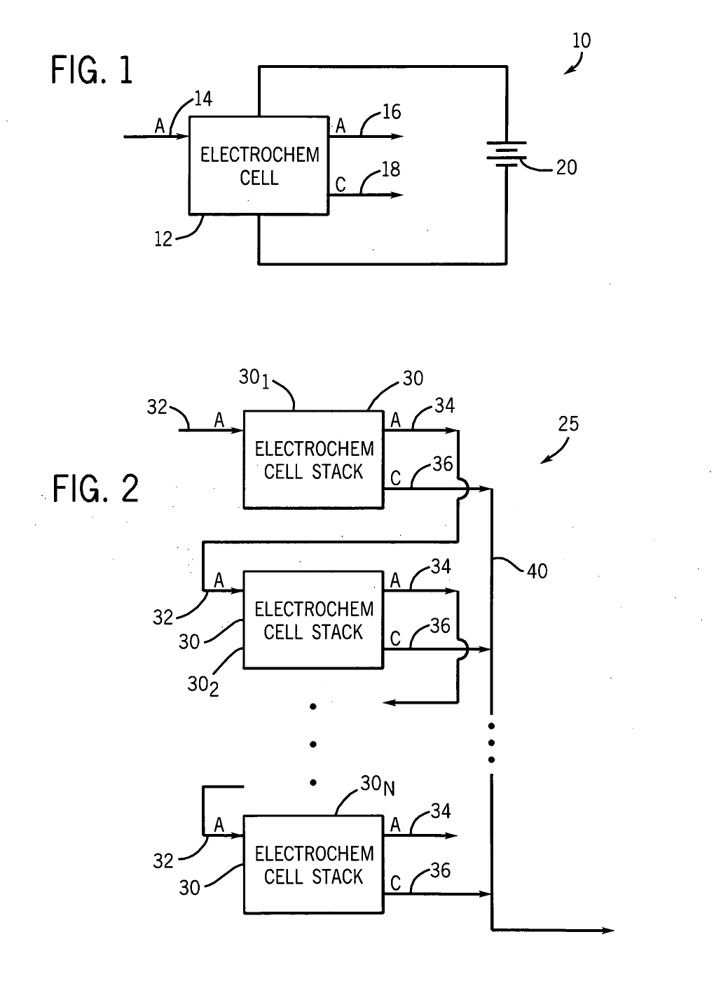

An electrochemical cell may be configured to produce a significantly pure and compressed gas flow. For example, referring to FIG. 1, an electrochemical cell 12 may include an anode inlet 14 that receives a mixture of gases, which are communicated to the anode side of the cell 12. The electrochemical cell 12 extracts a species (hydrogen, for example) of the incoming gas mixture and transports the selected species to the cathode side of the cell 12 to produce a purified and compressed flow of the selected species at the cell's cathode exhaust outlet 18. As a more specific example, the electrochemical cell 12 may produce a relatively pure flow of hydrogen (a flow of 99.9% hydrogen by volume, for example) at the cathode exhaust outlet 18 in response to a reformate flow (a flow of 50% of hydrogen by volume, for example) that is received at the anode inlet 14.

FIG. 1 also depicts a voltage source 20 that provides energy to facilitate the transport of the selected gas species between the anode and cathode sides of the electrochemical cell 12. The non-transported gas species exits the electrochemical cell 12 at its anode exhaust outlet 16.

Turning now to more specific details, the electrochemical cell 12 routes the incoming gas mixture (received at the anode inlet 14) over an anode catalyst/electrode assembly of the cell 12. At this assembly interface, the gas species to be selectively transported is broken down and ionized. Following this, the species is transported through an electrolyte layer of the electrochemical cell 12. The voltage source 20 provides the electromotive force for this transport. At a cathode catalyst/electrode assembly of the cell 12, the species is re-assembled and neutralized. The gas species, which has been selectively transported exits the electrochemical cell 12 at the cathode outlet 18; and the gas species which were not transported exit the electrochemical cell 12 at the anode exhaust outlet 16.

Selective hydrogen gas transport is achieved using a proton conductor of the cell 12. This proton conductor might be an alkaline electrolyte; liquid or solid acid; or a proton-exchange-membrane (PEM). In the case of the PEM, the membrane may be catalyst coated Nafion.

As a more specific example, the electrochemical cell 12 may include a PEM and may be configured to produce a substantially pure hydrogen flow. For this cell, a gas mixture that contains hydrogen enters the anode side of the cell. At the anode catalyst/electrode, the hydrogen is broken down and ionized. Electrons are moved by the voltage produced by the voltage source 20 to the cathode side of the device, and protons are transported across the PEM electrolyte. At the cathode catalyst/electrode layer the hydrogen molecules re-assemble. The external voltage source 20 provides the energy to drive both the transportation of electrons and protons. Purified hydrogen is then free to exit the cathode of the electrochemical cell 12 at the cathode exhaust outlet 18. Species which are not transported exit the electrochemical cell 12 as an anode exhaust waste stream at the anode exhaust outlet 16.

The anode catalyst layer may be selected to prevent build-up of contaminant species. For example, when carbon monoxide (CO) is present as one of species in the incoming gas mixture, a Pt—Ru catalyst mixture or alloy may be used for the anode catalyst layer. Then, when oxygen is present in sufficient volume, CO is oxidized by the Ru catalyst layer, preventing contamination of the Pt catalyst. As an example, air flow rates equal to four to eight percent of the hydrogen flow rate are sufficient to oxidize CO levels of about 100 parts per million (ppm). Such methods may be very useful in the case of hydrogen-rich gas mixtures, which are produced via fossil fuel reforming processes, because these mixtures often contain trace amounts of CO.

The electrochemical cell 12, when operated as a pump, may compress the purified product to the desired use or storage pressure. Therefore, need for additional mechanical compression may be eliminated. Compression is achieved by placing a back-pressure on the cathode side of the cell 12. When this is done, the species being transported (hydrogen, for example) becomes compressed upon transport from the anode side to the cathode side of the cell 12.

Hydrogen is not the only species that may be transported across the membrane of the electrochemical cell 12 and thus, purified. For example, when the electrolyte material is an oxygen ion conductor, such one of the solid oxide electrolytes that may be used in a solid oxide fuel cell, oxygen pumping may be performed to achieve the same functions listed above for hydrogen, except with oxygen as the process gas.

The electrochemical cell may be combined with additional cells to further purify and compress the end product. For example, an electrochemical cell pump 25, which is depicted in FIG. 2 may be used. The electrochemical cell pump 25 includes N cascaded electrochemical cell stacks 30 (electrochemical cell stacks 30₁, 30₂ . . . 30_{N} being depicted as examples). Each electrochemical cell stack 30 includes an anode inlet 32 that receives an incoming gas mixture, and the cell stack 20 is configured to selectively transport a gas species of this mixture to its cathode exhaust outlet 36. Thus, each electrochemical cell stack 30 further purifies the gas mixture that is received at its anode inlet 32. More specifically, the electrochemical cell stack 30₁ receives the incoming gas mixture to the electrochemical cell pump 25; the anode inlet 32 of the electrochemical cell stack 30₁ receives the anode exhaust (provided at anode exhaust outlet 34) from the electrochemical cell stack 30₁ and so forth. A cathode outlet 36 of each electrochemical cell stack 30 is connected to a shared exhaust line 40, which communicates a substantially pure flow of the selected gas species from the pump 25.

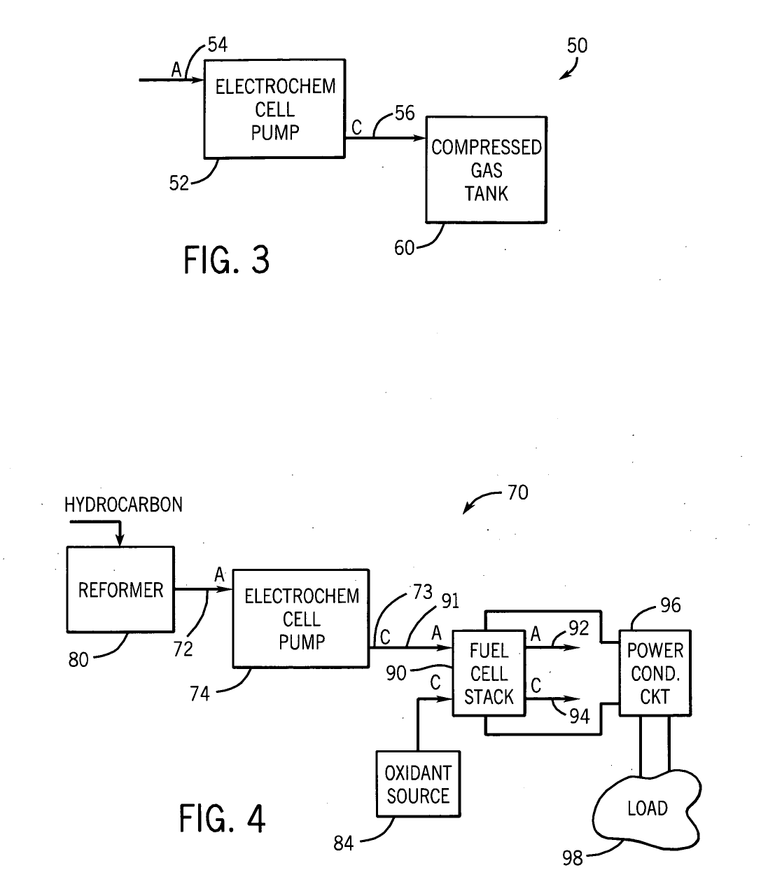

The efficiency of electrochemically compressing a purified hydrogen stream is far higher than can be achieved with the use of a mechanical compressor. Therefore, it is desirable to compress the gas that is produced by an electrochemical cell pump, without passing the gas through a mechanical compressor. For example, FIG. 3 depicts a system 50 in which an electrochemical cell pump 52 receives an incoming gas flow at its anode inlet 54 and produces a corresponding purified and compressed gas flow at its cathode exhaust outlet 56. As shown in FIG. 3, the compressed and purified gas flow may be stored in a compressed gas tank 60 that is connected directly to the cathode exhaust outlet 56, without an intervening mechanical compressor being located between the pump 52 and tank 60, in accordance with some embodiments of the invention.

As another example of the application of an electrochemical pump that directly furnishes a compressed and purified gas flow, FIG. 4 depicts a fuel cell system 70 indicates an electrochemical cell pump 74 to furnish a purified and compressed hydrogen gas flow, which is used as fuel for a fuel cell stack 90 of the system 70. In this regard, the electrochemical cell pump 74 includes an anode inlet 72 that receives a reformate flow from a reformer 80. In response to this flow, the electrochemical cell pump 74 produces a substantially pure hydrogen flow (as its cathode outlet 73) that is received (without further compression) at an anode inlet 91 of the fuel cell stack 90.

In response to the incoming hydrogen flow and an oxidant flow that is received from an oxidant source 84, the fuel cell stack 90 produces electrical power for a load 98. The fuel cell stack 90 may also include an anode exhaust outlet 92, as well as a cathode exhaust outlet 94. It is noted that the fuel cell system 70 may include power conditioning circuitry 96 that conditions the DC stack voltage that is provided by the fuel cell stack 90 into the appropriate form for the load 98.

Thus, because the electrochemical cell pump 74 directly compresses the purified fuel for the fuel cell stack 90, the overall efficiency of the fuel cell system 70 is increased, as compared to an arrangement in which a mechanical compressor is used to further pressurize the incoming fuel flow to the fuel cell stack 90 to the appropriate level.

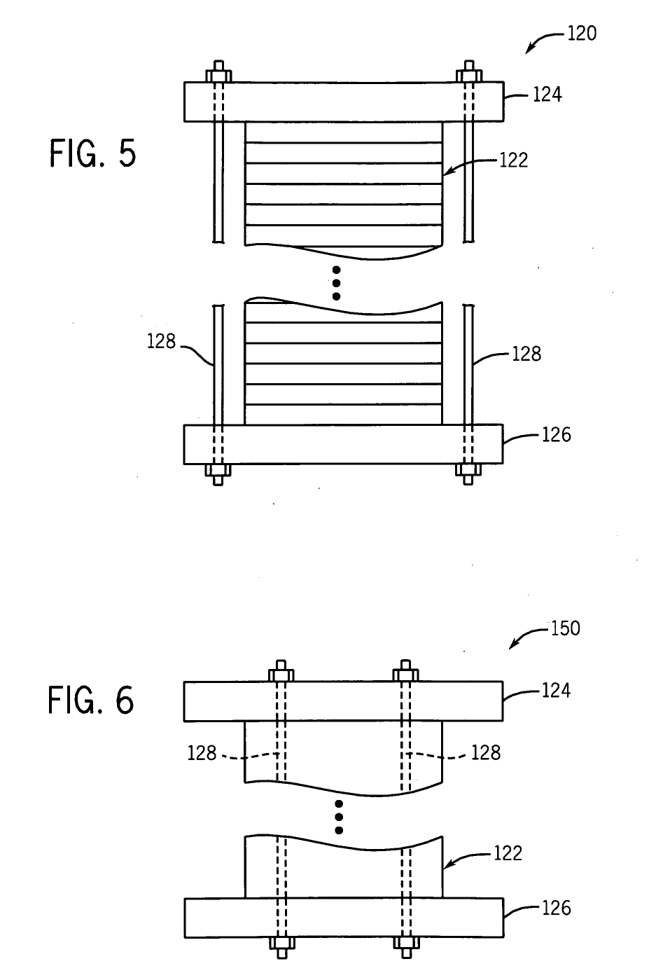

Referring to FIG. 5, for such purposes of energizing seals between flow plates and minimizing contact resistances, the flow plates of an electrochemical cell stack assembly are compressed together. Therefore, as depicted in FIG. 5, flow plates 122 of an electrochemical cell stack assembly 120 may be situated between upper 124 and lower 126 end plates. The end plates 124 and 126 in combination with tie rods 128 that extend between the upper 124 and lower 126 end plates maintain a compression force on the flow plates 122. During the assembly of the electrochemical cell stack assembly 120, the end plates 124 and 126; flow plates 122; and the gasket seals of the stack assembly 120 are compressed together by a press. The tie rods 128 are inserted through the end plates 124 and 126 and are secured to the stack assembly 120 via threaded connections (for example). Thus, the tie rods 128 are loading force members that maintain the compression on the components of the stack assembly 120 after the assembly 120 is removed from the press.

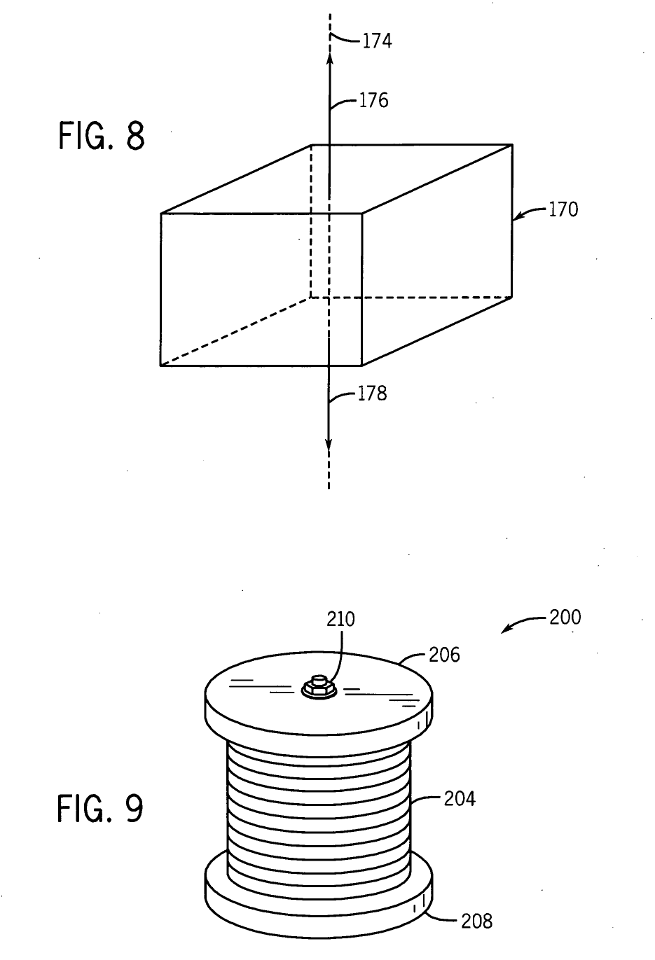

A difficulty with the stack assembly 120 of FIG. 5 is that when the stack is operated as an electrochemical pump, expansion forces are produced, which tend to bow, or warp, the flow plates 122. For example, when part of an electrochemical pump, the stack may produce a highly pressurized gas (a gas having a pressure on the order of 1000 to 5000 pounds per square inch (p.s.i.), for example). The internal expansion forces in the stack, which result from this highly pressurized gas may cause warping, or bowing, of the flow plates 122, if appropriate measures are not taken. Referring also to FIG. 8, the expansion force may be conceptualized as upward 176 and lower 178 expansion forces that extend generally along a center line 174 of a stack 170 of flow plates. In other words, the expansion forces are maximized along the center line 174 of the stack 170. Locating the tie rods 128 outside of the stack, as depicted in FIG. 5, may fail to properly compensate for the expansion forces, thereby leading to warping, or bowing, of the flow plates 122.

Alternatively, a fuel cell stack assembly 150 (see FIG. 6) may include tie rods 128 that extend through the stack of flow plates 122 near the outer perimeter of the stack. However, this positioning of the tie rods 128 may still fail to offset the expansion forces that are generated by the operation of the stack; and as a result, the flow plates may still experience bowing, or warpage.

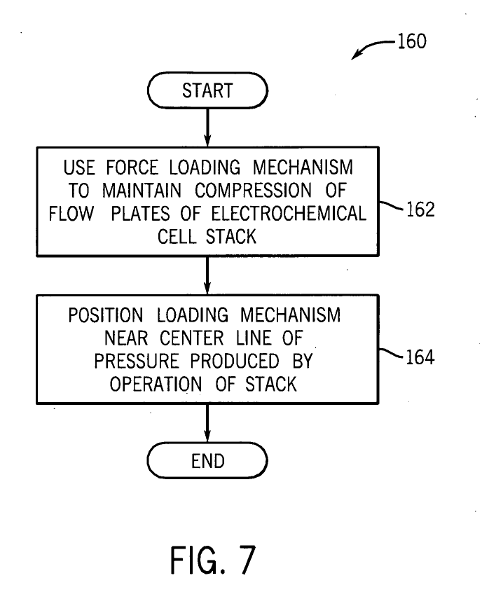

It has been discovered that by locating a compression loading force mechanism, such as one or more tie rods, near the center line of the electrochemical cell stack, bowing of the flow plates may be minimized, if not eliminated. More specifically, referring to FIG. 7, in accordance with some embodiments of the invention, a technique 160 includes using a force loading mechanism to maintain the compression of flow plates of an electrochemical cell stack, pursuant to block 162. The loading force mechanism is positioned (block 164) near the center line of the expansion pressure that is produced by operation of the stack. In some embodiments of the invention, this means that the loading force mechanism is positioned near the center line of the stack of flow plates. Due to this arrangement, the compression forces are maximized in a region of the stack in which the expansion forces are at their maximums.

As a more specific example, FIG. 9 depicts an exemplary embodiment 200 of an electrochemical cell stack assembly in accordance with the invention. It is noted that the electrochemical cell stack assembly 200 is depicted as being formed from circular, or disk-shaped, flow plates 204. However, other shapes, such as rectangularly-shaped flow plates may be used, in accordance with other embodiments of the invention.

As depicted in FIG. 9, in accordance with some embodiments of the invention, the disk-shaped flow plates 204 are located between upper 206 and lower 208 disk-shaped end plates, although other shapes for the end plates are possible in accordance with other embodiments of the invention. The end plates 206 and 208, in combination with a loading force mechanism 210, maintain a compression force on the flow plates 204. In this regard, in accordance with some embodiments of the invention, the loading force member 210 extends through a center line of the stack of the flow plates 204. The center line may be a line that extends through the center of each disk-shaped flow plate of the stack 204. This center line, in turn, also coincides with the region of the flow plate stack 204, which is associated with the highest expansion forces that are exerted by the electrochemical cells of the stack 204 during their operation. As a result, the effect of the compression force that is applied through the end plates 206 and the loading member 210 countering the pressure forces is therefore maximized to prevent bowing of the flow plates 204.

In accordance with some embodiments of the invention, the stack may use a one flow plate cell design, in which each electrochemical cell is formed from the upper surface of one flow plate and the lower surface of the adjacent flow plate. More particularly, one surface, or side, of the flow plate may be a cathode side of the flow plate and thus may be used to form the cathode chamber of the cell; and the opposite side of the flow plate may be the anode side and thus, be used to form the anode chamber of the adjacent cell. Membrane electrode assemblies (MEAs) are situated between each adjacent pair of flow plates of the stack.

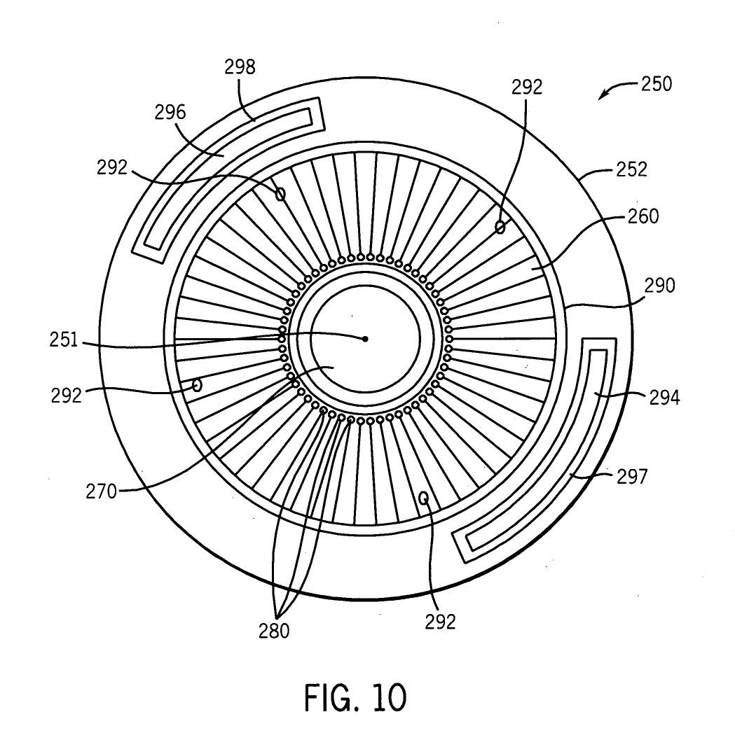

As a more specific example, FIG. 10 depicts an exemplary embodiment 250 of a disk-shaped flow plate in accordance with some embodiments of the invention. In particular, FIG. 10 depicts the cathode side of the flow plate 250.

The flow plate 250 is formed from a disk-shaped flow plate body 252 that is generally symmetrical with respect to a center 251 of the flow plate 250. Thus, the center line of the flow plate stack extends through the center 251 of the flow plate 250 and through the centers of the other flow plates of the stack. In accordance with some embodiments of the invention, an opening 270, which is concentric with respect to the center line of the stack, is formed in the center of the flow plate 250. The opening 270 receives the loading force member that extends through the stack along the stack's center line. In accordance with some embodiments of the invention, the opening 270 also serves to form part of the cathode exhaust plenum passageway for the stack. In this regard, when the flow plate 250 is assembled in the stack, the openings 270 of the flow plates align to form the cathode exhaust plenum passageway.

The flow plate 250 includes other openings 294 and 296, which form portions of other plenum passageways of the stack. In general, the openings 294 and 296 each are eccentric with respect to the center line 251, are located near the outer perimeter of the flow plate 250 and partially circumscribe the center line 251. In accordance with some embodiments of the invention, the openings 294 and 296 may be associated with anode flows. In this regard, the opening 294 may form a portion of the plenum passageway to communicate an incoming anode flow to the electrochemical cell, and the opening 296 may form part of the plenum passageway to communicate an anode exhaust from the electrochemical cell. Therefore, because the openings 294 and 296 are associated with anode flows, seals or gaskets 297 and 298 surround the openings 294 and 296, respectively, to isolate the anode flows from the cathode side (depicted in FIG. 10) of the flow plate 250.

The cathode side of the flow plate 250 includes an active region to communicate a cathode flow. For the case in which the electrochemical cell stack is an electrochemical pump, or purifier, this active region communicates the purified gas from the MEA of the cell. As depicted in FIG. 10, in accordance with some embodiments of the invention, the active region on the cathode side of the flow plate 250 may include flow channels 260 that are, in general, radially directed to flow cathode chamber gas into the cathode exhaust plenum. More specifically, the flow channels 260 are configured to flow the cathode chamber gas into small openings, or “dive-throughs,” which generally surround the periphery of the opening 270. The dive-throughs 280 communicate the cathode flow to a sealed region on the opposite side of the flow plate 250. This sealed region, in turn, is in fluid communication with the cathode exhaust plenum passageway. As depicted in FIG. 10, a seal 271, which is concentric to the center line 251, may be located radially inside the openings 280 and generally circumscribe the opening 270. The seal 271 in combination with another concentric seal 290 seal off the active region in between.

In accordance with some embodiments of the invention, a small number (four, for example) of openings 292 may be formed in the active region near the outer cell 290. The openings 292 effectively establish a bleed flow between the cathode and anode sides of the cell.

Other stack and plate designs are envisioned, all of which fall within the scope of the appended claims.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method comprising:
providing a loading force member to extend between end plates to compress flow plates of a stack of electrochemical cells together; and
positioning the member in a region of the stack in which a maximum pressure force is exerted due to operation of the stack.

2. The method of claim 1, wherein the maximum pressure occurs significantly along a centerline of the stack and the act of positioning causes the member to substantially extend along the centerline of the stack.

3. The method of claim 1, wherein the act of providing comprises providing a tie rod that extends through places of the stack.

4. The method of claim 1, further comprising:
operating the electrochemical cell stack as an electrochemical pump which produces said maximum pressure force.

5. The method of claim 1, wherein the act of positioning counters a tendency of the flows plates to bend due to a pressure force exerted by the operation of the stack.

6. The method of claim 1, further comprising:
forming the stack from disk-shaped flow plates.

7. A method comprising:
compressing flow plates of an electrochemical cell stack between end plates;
extending a loading member through the stack to compress the flow plates; and
positioning the loading member to extend substantially along a center line of the stack.

8. The method of claim 7, wherein the loading member is closer to the center line than to a second line parallel to the center line and located outside of the stack.

9. The method of claim 7, wherein the act of extending comprises extending a tie rod through the stack.

10. The method of claim 7, further comprising:
positioning the loading member to counter bowing of the flow plates due to pressure produced by operation of the electrochemical stack.

11. An apparatus comprising:
a stack of flow plates to form electrochemical cells which generate a pressure force on the flow plates during operation of the cells;
end plates; and
a loading force member to extend between the end plates to maintain the stack in compression, the loading force member positioned to maximize a compression force in a region of the stack in which the pressure force is maximized.

12. The apparatus of claim 11, wherein the maximum pressure occurs significantly along a centerline of the stack and the member substantially extends along the centerline of the stack.

13. The apparatus of claim 11, wherein the loading force member comprises a tie rod.

14. The apparatus of claim 11, wherein the positioning of the loading force member counters a tendency of the flows plates to bend due to a compression force exerted by the operation of the stack.

15. The apparatus of claim 11, wherein the flow plates comprise disk-shaped flow plates, and the loading force member extends through a center of each disk-shaped flow plate.

16. An apparatus comprising:
a stack of flow plates to form electrochemical cells; and
a loading force member to extend substantially along a center line of the stack to maintain compression of the flow plates.

17. The apparatus of claim 16, wherein the loading force member is closer to the center line than to a second line parallel to the center line and located outside of the stack.

18. The apparatus of claim 16, wherein the loading force member comprises a tie rod.

19. The apparatus of claim 16, wherein the loading force member counters bowing of the flow plates due to pressure produced by operation of the electrochemical stack.
